(19) United States
(12) Patent Application Publication
(10) Pub. No.: US 2003/0155059 A1
(43) Pub. Date: Aug. 21, 2003

(54) RADIAL MEDIUM TRUCK TIRE WITH MULTIFILAMENT TOP BELT

(76) Inventors: DANIEL ROGER FERNAND NOEL, ATTERT (BE); MURAT YASAR AHMET SUSUTOGLU, BISSEN (LU); MICHELE MARIE JOSEPH EMILE SPRIET, STEINSEL (LU); MUSTAFA GOKSOY, BETTENDORF (LU); FERNAND ANTOINE JOSEPH FOURGON, BASTOGNE (BE)

Correspondence Address: ROBERT W BROWN, THE GOODYEAR TIRE & RUBBER COMPANY, PATENT & TRADEMARK DEPARTMENT D 823, 1144 EAST MARKET STREET, AKRON, OH, 44309-3531, US

(21) Appl. No.: 09/530,562

(22) PCT Filed: Nov. 19, 1997
(86) PCT No.: PCT/US97/21161

(51) Int. Cl. B60C 9/20; B60C 9/00; B60C 9/18

(52) U.S. Cl. 152/527; 152/526; 152/534; 152/536

(57) ABSTRACT

A radial medium radial truck (RMT) tire has belt or breaker plies which are reinforced by organic reinforcement cords or filaments. In the preferred embodiment, organic multifilaments are used in the top belt or breaker plies which have the following characteristics: at least a gauge of 420×2 dTex to about 3300×3 dTex, a tenacity of about 35 cN/Tex to about 200 cN/Tex, an initial modulus of at least 30 g/denier (250 cN/Tex) and a shrinkage of about 0.1-10 %. When an organic polymer reinforcement is used in the top belt or breaker in the belt package of a tire, scrapping of tires during a retreading operation because of corrosion is greatly reduced. In addition, acceptance for retreadability is increased because of reduced top belt or breaker damage, allowing for easier preparation for the retreading. Moreover, the invention relates to an improved construction to reduce defects known as blows.

### BACKGROUND OF THE INVENTION

The present invention relates to radial truck tires, preferably radial medium truck (RMT) pneumatic tires. The treads of RMT tires are subject to puncture from stones and other sharp objects in the road surface. In many cases, although the puncture is not deep enough to penetrate the belt package and destroy the tire, it is deep enough to expose the steel reinforcement cords of the belt package to water and air, and such exposure can cause the belt package to corrode. This problem is aggravated when tires are used in mixed service, i.e., partially on paved surfaces and partially on non-paved surfaces. Although rust does not significantly affect the strength of the reinforcement ply or the strength of the total belt package, tires are often scrapped if excessive corrosion is observed on the top steel reinforced belt when the tread is skived or buffed from the tire in preparation for retreading. Processing of such casings reduces the efficiency of the retreading operation.

In a related application to a common assignee with the present invention, U.S. patent application Ser. No. 08/427,524, entitled RADIAL MEDIUM TRUCK TIRE, which is incorporated by reference in its entirety herein, it was proposed to replace some of the steel reinforced belts in the, belt package, and at least the top belt, with a non-corrosive belt made with organic monofilament reinforcement, such as for example obround of polyamide monofilaments, or to add such a belt to the top of the belt package for such purpose. Monofilament of similar structure have been used in radial ply tires as described in U.S. Pat. No. 4,850,412 issued to Gupta, Jul. 25, 1989.

The present invention also relates to preventing defects known as blows or blisters which are caused while curing the tire by the presence of air or other gases within the body of the tire being cured. These defects can involve local separations, i.e., between the rubber and one or more of the reinforcement cords which make up the reinforcing ply of a pneumatic tire, between two rubber components, or within one rubber component. Air can become trapped in or between the layers of materials which are superimposed on one another in the course of building the tire, or can in some instances enter into the tire during a time lapse while building the tire, or can in some instances enter into the tire during the time lapse between the building of the tire and the placing of the tire into a curing mold. Occasionally, small quantities of air can even be forced into the body of the tire by the closing of the curing mold.

It has been known in the tire making art that tire reinforcement cords contain passages extending generally throughout the length of the cord, lying between and bounded by the filaments which make up the cords, and that air or other gases can travel along such passages. It has been observed that the treatment of tire reinforcement cords, such as stretching heated cords of continuous filament materials, such as polyester and polyamide, tends to significantly reduce the cross sectional area of the interfilamentary passages. Stretching of heated cords can also result in the reduction of the cross sectional area of the individual filaments and the compacting of the filaments into a closer relationship one to another.

### OBJECTS AND SUMMARY OF THE INVENTION

It is an object of the present invention to provide a radial medium radial truck (RMT) tire having a top belt or breaker ply which is reinforced by organic multi-filament reinforcement cords, the tire being as defined in one or more of the appended claims and, as such, having the capability of being constructed to accomplish one or more of the following subsidiary objects.

An object of the present invention is to provide an improved RMT tire with a top protective layer made of polyamide multi-filaments.

Still another object of the present invention is to provide an improved RMT tire with a protective layer made of polyamide multi-filaments that have a low material stiffness, that are corrosion free, have a strong adhesion to rubber.

Yet another object of the present invention is to provide an improved RMT tire with a protective layer made of polyamide multi-filaments that resists localized damage and is convenient for retreading.

Still another aspect of the present invention is to provide a top multi-filament reinforcement ply having gas absorbing or bleeder reinforcing cords embedded in the rubber or rubber-like material.

Accordingly, an improved pneumatic radial medium truck tire of the invention comprises at least one pair of parallel annular beads, at least one carcass ply wrapped around the beads, a plurality of belts or breakers disposed over the carcass ply in a crown area of the tire, tread disposed over the belts or breakers, and sidewalls disposed between the tread and the beads. The majority of the belts or breakers in the tire are reinforced with steel filaments or cords. The top belt or breaker as well as any remaining belts or breakers are reinforcing cords comprised of multi-filaments constructed of twisted strands of an organic polymer. In an illustrated embodiment, the organic multi-filaments comprise strands of yarn twisted together into a generally circular cross section. The organic multi-filaments are formed of about 420 dTex×2 strands to about 3300 dTex×3 strands. The multi-filament constructed from 420 dTex×2 strands twisted to between about 3 to about 20 turns per inch (about 1.2 to about 7.9 turns per centimeter) is smaller then that formed of 3300 dTex×3 strands twisted to between about 3 to about 7 turns per inch (about 1.2 to about 2.8 turns per centimeter). The end count of the smaller 2 strand multi-filament is between about 10 to about 50 strands per inch (about 3.9 to about 19.7 strands per centimeter) while the end count of the larger multi-filament is between about 5 to about 17 strands per inch (about 2.0 to about 6.7 strands per centimeter). The multi-filament constructed from 2100 d Tex×3 strands twisted to between about 3 to about 9 turns per inch (about 1.2 to about 3.5 turns per centimeter) are used with an end count of between about 7 to about 22 strands per inch (about 2.8 to about 8.5 strand per centimeter).

The strands of the multi-filament have a tenacity of at least 35 cN/Tex, an initial modulus of at least 250 cN/Tex, an elongation at break of about 2 to about 40%, and a shrinkage of about 0.1 to about 10%. In various embodiments of the invention, the top reinforcement ply or breaker is a polyamide multi-filament, reinforced ply wherein the reinforcement cords have an angle of 0° to 35° with respect to the EP of the tire. In some such constructions, the overlay/top breaker ply extends beyond the edges of the other breakers, and the direction of the reinforcing cords are maintained at the same direction as the steel reinforcement cords in the breaker ply next radially below, or are at opposite directions which cross the steel reinforcement cords.

In accordance with another aspect of the present invention, the top layer multi-filament reinforcement functions as gas absorbing reinforcing cords embedded in rubber or rubber-like material.

### BRIEF DESCRIPTION OF THE DRAWINGS

FIG. 1 is a cross-sectional view of a tire according to one embodiment of the invention taken in a plane that contains the axis of rotation of the tire;

FIG. 2 illustrates a portion of a reinforcing ply constructed of multi-filament strands;

FIG. 3 is an enlarged cross-sectional view of one embodiment of a multi-filament cable suitable for use in the present invention; and

FIG. 4 is an enlarged cross-sectional view of another embodiment of a multi-filament cable suitable for use in the present invention.

### DEFINITIONS

As used herein and in the claims, the terms

“axial” and “axially” refer to directions which are parallel to the axis of rotation of a tire;

“radial” and “radially” refer to directions that are perpendicular to the axis of rotation of a tire;

“bead” refers to that part of a tire comprising an annular tensile member wrapped by ply cords and shaped, with or without other reinforcement elements to fit a designed tire rim;

“carcass plies” refers to the tire structure apart from the belt structure, tread, undertread, and sidewall rubber but including the beads, (carcass plies are wrapped around the beads);

“equatorial plane (EP)” refers to a plane that is perpendicular to the axis of rotation of a tire and passes through the center of the tire's tread;

“belt” or “belt ply” refers to an annular layer or ply of parallel cords, woven or unwoven, underlying the tread, not anchored to the bead, and having cord angles of from 12° to 35° with respect to the EP of the tire;

“breaker plies” refers to annular reinforcement members in the crown area of a tire having longitudinal reinforcement members having an angle (in the illustrated embodiment) with respect to the equatorial plane of the tire of about 5° less than the angle of such reinforcement members in the bias carcass plies:,

“crown” refers to substantially the outer circumference of a tire where the tread is disposed;

“rivet” refers to the amount of perpendicular distance between two adjacent cords;

“tenacity” refers to breaking stress expressed as force per unit linear density of an unstrained specimen (cN/Tex or gm/denier), (usually used in textiles);

“modulus” refers to the ratio of the change in stress to the change in strain; and

“organic” refers to compounds, including polymers, containing a carbon backbone or structure, which can be shaped, stretched or formed into a particular physical configuration.

### DETAILED DESCRIPTION OF THE INVENTION

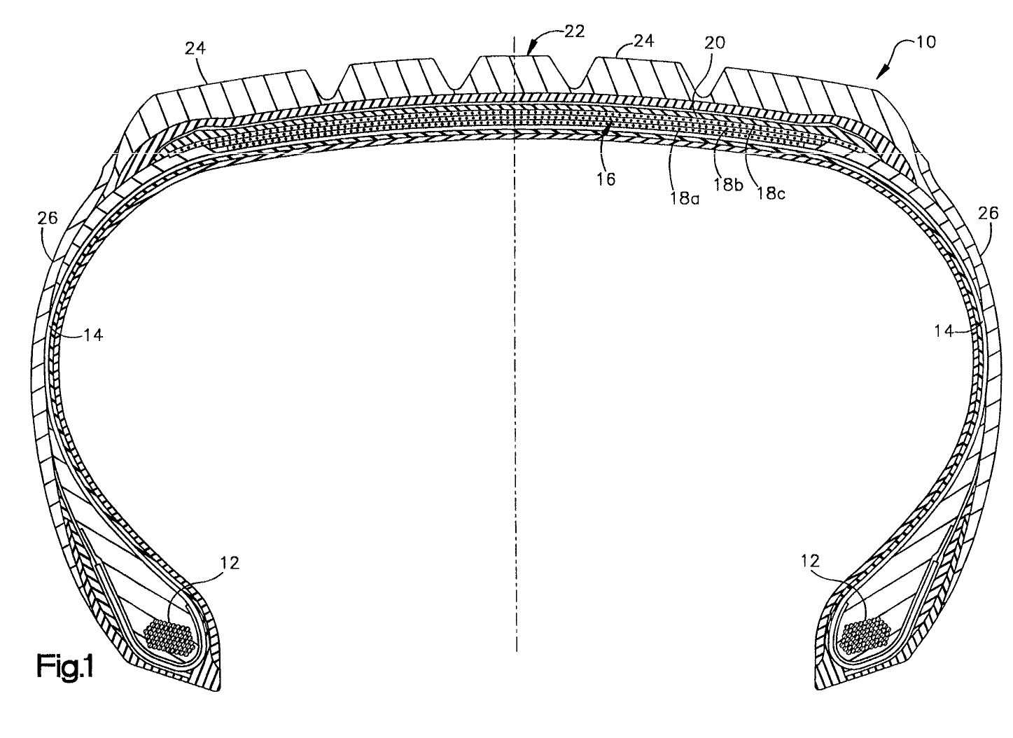

With reference now to FIG. 1, a preferred embodiment of a pneumatic tire 10 is illustrated which comprises a pair of substantially parallel annular beads 12. Carcass ply(ies) 14 are wrapped around the beads, belts or breakers 16 comprising three, steel cord reinforced breaker plies 18a, 18b, 18c and one organic polymer reinforced ply 20 disposed over the carcass ply(ies) 14 in a crown portion 22 of the tire. Tread 24 is disposed over the belts or breakers and sidewalls 26 are disposed between the tread and the beads.

The carcass plies 14 and the breaker plies 18, as is common in the tire making art, are reinforced with substantially parallel, longitudinal reinforcing members. The present invention relates specifically to pneumatic tires which have a belt or breaker ply 20 which is at least partially reinforced by organic cords or filaments. The organic cords or filaments are formed of twisted yarns of any organic material, having sufficient strength and durability for the purpose described, can be used in the invention. Examples of such materials are thermoplastics such as polyamide; polyesters such as polyethyleneterephthalate (PET), and polyethylenenapthalate (PEN); and polyvinyl alcohol (PVA).

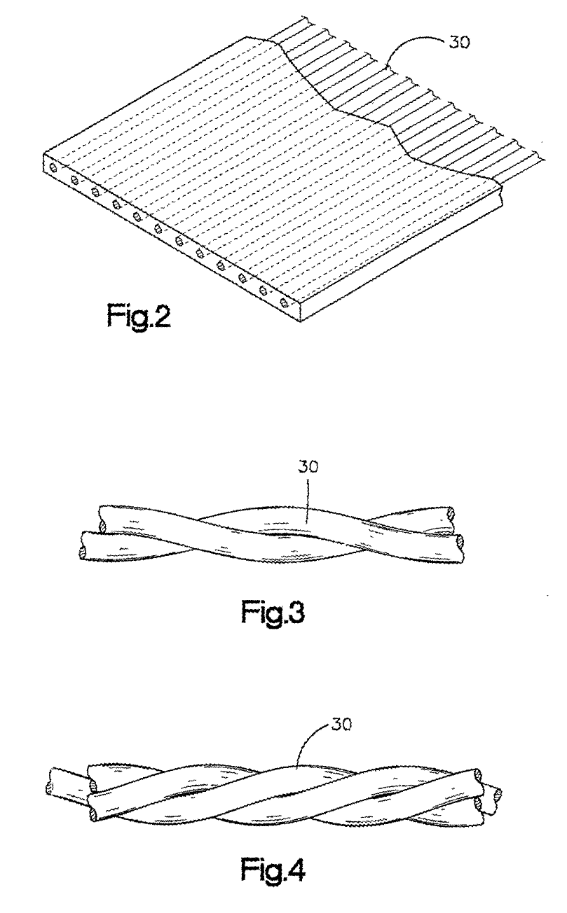

In the illustrated embodiment, longitudinal, reinforcing tire cords comprising polyamide, multi-filaments have been used in constructing ply 14. The polyamide multi-filaments used in the belt or breaker ply 20 comprise strands of yarn twisted together into a generally circular cross section as shown in FIG. 2. The organic multi-filaments are formed from about 420 dTex×2 strands to about 3300 dTex×3 strands of twisted yarn. The strands of material from about 420 dTex to about 2100 dTex are estimated to have a tenacity of at between about 35 cN/Tex to about 200 cN/Tex, an estimated initial modulus of at least 250 cN/Tex, an estimated elongation at break of about 2 to about 40%, and an estimated shrinkage of about 0.1% to about 10%. Multi-filaments of polyamide are particularly well suited for implementing the invention.

The multi-filament constructed from 420 dTex×2 strands of twisted yarn twisted to between about 3 to about 20 turns per inch (about 1.2 to about 7.9 turns per centimeter) is smaller then that formed of 3300 dTex×3 strands of yarn twisted to between about 3 to about 7 turns per inch (about 1.2 to about 2.8 turns per centimeter). The end count of the smaller 2 strand multi-filament is between about 10 to about 50 strands per inch (about 3.9 to about 19.7 strands per centimeter) while the end count of the larger three strand multi-filament is between about 5 to about 17 strands per inch (about 2.0 to about 6.7 strands per centimeter).

With reference to FIG. 2, multi-filaments 30 may be disposed in spaced, parallel relationship to one another as they are incorporated in an elastomeric material to form a top breaker ply 20 of the tire 10. With reference now to FIGS. 3 and 4, cross sections of polyamide multi-filaments 30 particularly suited for practicing the invention are illustrated. Typically multi-filaments of two or three twisted strands, as shown in FIGS. 3 and 4, respectively, can be used. In order to improve the adhesion of rubber to the multi-filaments, it may also be of advantage in practicing the invention to coat the multi-filaments with a suitable adhesive, for example a conventional RFL adhesive, or the otherwise treat the multi-filaments to promote adherence of rubber to the multi-filaments.

Another aspect of the present invention is the ability of the multi-filament construction to act as bleeder cords to prevent defects known as blows or blisters caused while curing the tire by the presence of air or other compressible gases within the body of the tire being cured.. That is, when the tire is constructed, it is placed in a curing mold and heated after being inflated to a high pressure of about 400 pounds per square inch (psi) the top multi-filament reinforcement ply function as gas absorbing reinforcing cords embedded in rubber or rubber-like material. The gas or air can become trapped in or between the layers of materials which are superimposed on one another in the course of building the tire, as previously discussed. During the curing step, the molecules of air can either be absorbed in the top multi-filaments embedded in rubber or rubber-like material. This feature of the present invention, reduces tire defects from local separation between the rubber and one or more of the reinforcement cords which make up the reinforcing ply of a pneumatic tire.

In the tire 10 of the invention, as shown in FIG. 1, the carcass ply 14 is wrapped over beads 12 such that reinforcement cords have an angle of between about 10° and about 90°, preferably about 90° with respect to the equatorial plane of the tire. By definition, the reinforcement members in belt or breaker plies 18a, 18b, 18c have an angle at least about 5° less than the angle of the reinforcement members in the carcass plies, and accordingly, the reinforcement members in the belt or breaker plies have an angle of between about 0° and about 35°, preferably about 22°, with respect to the equatorial plane of the tire.

In an exemplary illustrated embodiment of the invention, RMT tires have been made wherein the conventional construction has been changed by removing the top steel reinforced belt ply and replacing it with one polyamide multi-filament reinforced ply 20 over the three steel reinforced belt plies 18a, 18b, 18c. The end count for the steel reinforced plies may vary from about 8 to about 18 ends per inch (epi) {about 3.1 to about 7.1 ends per centimeter (epc)}. The multi-filament reinforced belt ply 20 has an angle of about 0° to about 35° with respect to the EP of the tire. It is within the terms of the invention for the multi-filament, non-wire reinforced ply 20 to extend beyond the edges of the other breaker plies 18a, 18b, 18c . Moreover, the direction of the reinforcing multi-filaments is maintained at the same direction as the steel reinforcement cords in the breaker ply 18c next radially below. By applying the top ply 20 wherein the cords have the same angle as the reinforcement cord in the ply 18c below, a less stiff belt package, that has improved flexibility and enveloping properties, is provided.

Those skilled in the art will recognize that while other steel reinforced belts in the belt package may be replaced by plies reinforced with polyamide reinforcement cords, it being most important to the present invention, with an object to prevent corrosion in RMT tires, that the top belt in the belt package is a multi-filament, organic reinforced ply.

Another important advantage of the improvement to the tires made according to the invention is improved retreadability because the damage to the top breaker is reduced. During the retreading process, the time required for the buzz out operation (the grinding away of damaged spots created by the penetration of stones into the belt package) is shortened, and the possibility of breaker edge separation is reduced. These properties are believed to be due, at least in part, to improved enveloping properties of the tread; improved aged adhesion possible between an organic cord or multi-filament and rubber as compared to the aged adhesion between rubber and steel; and the corrosion resistance of the organic multi-filament reinforcement as compared to the corrosion resistance of steel. Other advantages of the multi-filament reinforcement is that the damage caused by any cuts in the tire which reach the top multi-filament belt stays localized. Moreover, any damage to the multi-filament belt generally requires only soft wire brushing. Even excessive top belt damage can be removed by rasping with a coarse file. In any case, there is no need for a special debelting device. Even accidental excessive regrooving which normally exposes the steel cord protective layer to corrosion, does not detract from the retreadability of tire with polyamide multi-filament protective layer.

While the invention has been specifically illustrated and described, those skilled in the art will recognize that the invention may be variously modified and practiced without departing from the spirit of the invention. The scope of the invention is limited only by the following claims.

1. A pneumatic radial medium truck tire characterized by at least one pair of parallel annular beads, at least one carcass ply wrapped around the beads, at least three belts or breakers disposed over the carcass ply in a crown area of the tire, tread disposed over the belts or breakers, and sidewalls disposed between the tread and the beads, wherein the two or three bottom belts or breakers closest to the carcass ply are reinforced with steel filaments or cords, and the top belt or breaker disposed closest to the tread is reinforced with multi-filaments or cords comprised of an organic polymer.

2. The tire of claim 1 characterized in that the organic multi-filament or cord comprises polyamide multi-filaments used in the breaker plies are at least about 420 dTex , have a tenacity of at least about 35 cN/Tex, an initial modulus of at least about 250 cN/Tex, an elongation at break of at most about 40%, and a shrinkage of at most about 10%.

3. The tire of claim 1 characterized in that the organic multi-filament or cord comprises polyamide multi-filaments used in the breaker plies are from about 420 dTex to about 2100 dTex , have a tenacity of at between about 35 cN/Tex to about 200 cN/Tex, an initial modulus of at least about 250 cN/Tex, an elongation at break of about 2 to about 40%, and a shrinkage of about 0.1% to about 10%.

4. The tire of claim 2 characterized in that the angle of organic reinforcement cords in the organic belt have an angle with respect to the EP of the tire which is substantially the same as or opposite to the angle, of the steel reinforcing cords of the adjacent belt radially inward of the organic belt.

5. The tire of claim 2 characterized in that the axial edges of the organic belt extend anally beyond the axial edges of the steel belts.

6. The tire of claim 2 characterized in that the organic belt has parallel reinforcement multi-filaments at a concentration of about 5 to about 36 ends per inch and the steel belts have parallel cord reinforcement it a concentration of 8 to 18 ends per inch.

7. The tire of claim 2 characterized in that the reinforcing filaments in the organic polymer belt are coated with a resorcinol formaldehyde latex (RFL) adhesive.

8. The tire of claim 2 characterized in that the reinforcing filaments in the organic polymer belt are coated with an epoxy subcoat and a resorcinol formaldehyde latex (RFL) adhesive top coat.

9. The tire of claim 3 characterized in that the organic reinforcement comprises one ply from multi-filaments of 420 dTex×2 strands of twisted yarn twisted to between about 3 to about 20 turns per inch.

10. The tire of claim 3 characterized in that the organic reinforcement comprises one ply having from 2100 dTex×3 strands of yarn twisted to between about 3 to about 9 turns per inch.

11. A pneumatic radial medium truck tire characterized by at least one pair of parallel annular beads, at least one carcass ply wrapped around the beads, two to twelve belts or breakers disposed over the carcass ply in a crown area of the tire, tread disposed over the belts or breakers, and sidewalls disposed between the tread and the beads, wherein the majority of the belts or breakers are reinforced with steel filaments or cords, and the remaining belts or breakers are reinforced with filaments or cords comprised of an organic polymer, wherein a polyamide, multi-filament reinforced belt ply wherein the reinforcement cords have an angle of between about 0° to about 70° with respect to the EP of the tire comprises the top ply of the belt package.

12. The tire of claim 11 characterized in that an organic multi-filament reinforced ply is used as an overlay/top breaker wherein the ply extends beyond the edges of the other breakers, and the angle of the reinforcing cords are maintained at the same angle as the steel reinforcement cords in the breaker ply next radially below.

13. The tire of claim 11 characterized in that the organic multi-filament or cord comprises polyamide multi-filaments used in the breaker plies are at least about 420 dTex , have a tenacity of at least about 35 cN/Tex, an initial modulus of at least about 250 cN/Tex, an elongation at break of at most about 40%, and a shrinkage of at most about 10%.

14. The tire of claim 13 characterized in that the organic multi-filament or cord comprises polyamide multi-filaments used in the breaker plies are from about 420 dTex to about 2100 dTex, have a tenacity of at between about 35 cN/Tex to about 200 cN/Tex, an initial modulus of at least about 250 cN/Tex, an elongation at break of about 2 to about 40%, and a shinkage of about 0.1% to about 10%.

15. The tire of claim 14 characterized in that the organic reinforcement comprises one ply from multi-filaments of 420 dTex×2 strands of twisted yarn twisted to between about 3 to about 20 turns per inch.

16. The tire of claim 14 characterized in that the organic reinforcement comprises one ply having from 2100 dTex×3 strands of yarn twisted to between about 3 to about 9 turns per inch.
